(19) United States
(12) Patent Application Publication
(10) Pub. No.: US 2010/0185969 A1
(43) Pub. Date: Jul. 22, 2010

(54) LIGHT CONTROL SYSTEM WITH A USER INTERFACE FOR INTERACTIVELY CHANGING SETTINGS IN A LIGHTING SYSTEM AND METHOD FOR INTERACTIVELY CHANGING SETTINGS IN A LIGHTING SYSTEM WITH A USER INTERFACE

(75) Inventors: Matthias Wendt, Wurselen (DE); Mark Henricus Verberkt, Eindhoven (NL); Felix Ogg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/666,811

(22) PCT Filed: Jun. 25, 2008
(86) PCT No.: PCT/IB08/52530

§ 371 Date: Dec. 28, 2009

(30) Foreign Application Priority Data
Jun. 29, 2007 (EP) 07111416.9

(51) Int. Cl. G06F 3/048

(52) U.S. Cl. 715/771

(57) ABSTRACT

The invention relates to a light control system (10) with a user interface (12) for interactively changing settings in a lighting system, particularly a user interface enabling easy and comfortable interactive changes of light scenes created by a lighting system. A basic idea of the invention is to graphically represent a scenery to be lit such as a shop with furnishings and several targets for lighting effects such as mannequins and clothing racks with a user interface, and to offer a user to activate locations and targets of interest and to select lighting effects for a selected location or target of the scenery to be lit. In an embodiment of the invention, the user interface (12) is adapted to graphically represent a scenery to be lit (50) and to allow selection of locations and targets (52, 54, 56, 58) of the scenery to be lit (50) and lighting effects for a selected location or target.

The invention relates to a system and method for interactively changing settings in a lighting system with a user interface, particularly a user interface enabling easy and comfortable interactive changes of light scenes created by a lighting system.

Lighting systems are becoming more advanced, flexible and integrated, and will enable new forms of lighting including color lighting and dynamics, which will make it possible to create a whole variety of numerous light designs with a single lighting system. In known systems the operator of a light installation has to know all available properties that can be adjusted for a certain object to set-up a light design. If a user likes to interactively modify the light settings she/he could do that by traditionally adjusting lamp settings manually. However, that requires in-depth knowledge of the related lamps and the possible adjustments, and may be tedious. US 2005/0248299 A1 discloses a light system manager comprising a graphical user interface (GUI) for complex light installations. However, this light system manager is looking for highly homogenous lamp installations, which means only the same type of lamp distributed in space, but with a freedom in geometrical arrangement. So, if there a lamp is exchanged by lamp with e.g. more available colors, the user interface of this light system manager will not look differently than before.

It is an object of the invention to provide a light control system with a user interface for interactively changing settings in a lighting system and a method for interactively changing settings in a lighting system with a user interface, which are suitable for highly inhomogeneous lighting systems.

The object is achieved by the independent claim(s). Further embodiments are shown by the dependent claim(s).

A basic idea of the invention is to graphically represent a scenery to be lit such as a shop with furnishings and several targets for lighting effects such as mannequins and clothing racks with a user interface, and to offer a user to activate locations and targets of interest and to select lighting effects for a selected location or target of the scenery to be lit. For example, the user interface may graphically represent a certain shop in a two-dimensional view like an architectural drawing, and the shop's inner interior like clothing racks at the different locations. A user may then interactively select certain areas of the shop in order to create a special lighting in the areas. For example, the user selects these areas with an input device such as a mouse, keyboard, pen or any other input means, and then selects the desired lighting effect for the selected areas particularly from a collection of lighting effects with the user interface. Thus, users are able to comfortably design lighting scenes in an interactive way. Furthermore, users may not know any special technical details of a certain lighting system, but can design lighting effects themselves, without requiring in-depth knowledge of the related lamps and the possible adjustments. The invention is particularly suitable for inhomogeneous lamp installations like in normal shops due to the graphical representation of sceneries to be lit and the possibility to select locations and targets and desired lighting effects with the user interface.

According to an embodiment of the invention, a light control system with a user interface for interactively changing settings in a lighting system is provided, wherein

the user interface is adapted to graphically represent a scenery to be lit and to allow selection of locations and targets of the scenery to be lit and lighting effects for a selected location or target.

The selectable lighting effects may be for example pre-programmed effects, pictures or changeable parameters like color, color temperature or brightness.

The light control system may be adapted in a further embodiment of the invention to generate an abstract light scene description depending on the user interface selections of a location or target and a lighting effect for the selected location and target.

According to a further embodiment of the invention, the user interface may be further adapted to present the lighting effects for a location or target after the selection of the location or target. For example, when a certain location in a shop or a mannequin is selected with the user interface, the available lighting effects may be presented. Thus, a user does not need to know any details about the light system installation in the shop.

The user interface may be in a further embodiment of the invention adapted to present only appropriate lighting effects for a selected location or target. For example, when a user selects a mannequin a target, the user interface may only present appropriate lighting effects such as spot lights, but not wall washing effects.

The light control system may be in a further embodiment of the invention adapted to receive a description file of the scenery to be lit, for example a XML file containing an abstract description of a lighting system in shop. In this file, targets may be named and contain coordinates. Particularly, the file enables the user interface to create a graphical presentation of the described scenery to be lit.

According to a further embodiment of the invention, the light control system may comprise a lighting effects database and may be further adapted to read lighting effects, which are connected to the selected location or target, from the lighting effects database. The lighting effects database may particularly contain all possible assets for lighting effects, for example all installed lamps with their control parameters and the possible light effects. When the light control system reads the description file of a scenery to be lit, which contains only abstract descriptions of the lamps contained in a lighting scene, the system can read all further information regarding the contained lamps from the lighting effects database. Thus, the detailed parameters and lighting effects of single lamps may not be included in the description files of sceneries to be lit which makes them smaller and less complex and, thus, more easy to understand. In addition without the specific effects in the scene description file this description gets more location independent.

In a further embodiment of the invention, the light control system may be adapted to receive detection signals for targets, wherein the user interface is further adapted to show or hide targets depending on the received detection signals. This allows reflecting position changes of targets of the scenery to be lit. For example, automatic means for detecting position changes of targets may be installed in a shop. The automatic means may create detection signals of the monitored targets such as mannequins. If a target is moved from one location in the shop to another one, this may be indicated by the automatic means by sending a respective detection signals which may be processed by the light control system in that the new position is reflected in the graphical presentation of the lighting scene of the shop, i.e. the user interface visualization is modified appropriately.

In a yet further embodiment of the invention, the light control system may be adapted to receive sensor information, wherein the user interface is further adapted to reflect the received sensor information in the graphically represented scenery to be lit. Particularly, the user interface may be further adapted in an embodiment of the invention to reflect the received sensor information in the graphically represented scenery to be lit by recoloring certain targets or locations related to the received sensor information. This gives a user of the user interface further possibilities in creating a lighting atmosphere with a lighting system. For example, a movement sensor may be installed in a wall or a mannequin in a shop. The sensor information may then be used by the light system to visualize movement, for example people walking through the shop may initiate the sensor information and may be visualized by for example recoloring of some locations in the graphically presented scenery to be lit. A user may then react on this color change and, for example, simply adapt the lighting effects in this location. This enables a user for example to set a separate effect dependant of visitor presence or monitor that the presence sensor is well positioned.

In a yet further embodiment of the invention, the user interface may be adapted to allow setting of sensor threshold values for conditional scene descriptions. For example, if a certain sensor threshold value preset by a user is exceeded by real time sensor information, the user interface may switch to another scene description in order to create another lighting scene with the light system. Naturally, each lighting effect could be manually overwritten by user in order to offer the necessary flexibility in using the light control system.

In an embodiment of the invention, the user interface may be further adapted to allow setting different lighting effects for different sensor values. For example, the user interface may offer more dynamic lighting effects such as blinking and dazzling lights in areas or locations of a shop, where sensor values indicate a high shopper's frequency, while in other areas, where sensor values indicate a lower shopper's frequency, more static lighting effects such as dimmed and discreet colors may be offered by the user interface.

The light control system may comprise according to a further embodiment of the invention code generation means which are adapted to generate the abstract light scene description from the user interface selections of locations and/or targets and respective lighting effects for the selected locations and/or targets. The code generation means may be implemented for example by a kind of compiler program which is able to compile user inputs from the user interface into an abstract light scene description such as a XML file. This XML file may then be further processed by a special compilation program for generating control signals for a concrete lighting system.

The invention relates in a further embodiment of the invention to a method for interactively changing settings in a lighting system with a user interface, comprising

graphically representing a scenery to be lit with the user interface, and

selecting locations and targets of the scenery to be lit and lighting effects for a selected location or target.

According to an embodiment of the invention, the method may further comprise creating an abstract light scene description depending on the selections of a location or target and a lighting effect for the selected location and target.

The method may further comprise presenting the lighting effects for a location or target after the selection of the location or target. Particularly, the method may further comprise presenting only appropriate lighting effects for a selected location or target.

In a further embodiment of the invention, the method may comprise receiving a description file of the scenery to be lit.

In a yet further embodiment of the invention, the method may comprise reading lighting effects, which are connected to the selected location or target, from a lighting effects database.

In a yet further embodiment of the invention, the method may comprise receiving detection signals for targets, wherein the user interface shows or hides targets depending on the received detection signals.

According to an embodiment of the invention, the method may further comprise receiving sensor information, wherein the user interface reflects the received sensor information in the graphically represented scenery to be lit.

The user interface may reflect the received sensor information in the graphically represented scenery to be lit by recoloring certain targets or locations related to the received sensor information, according to a further embodiment of the invention.

According to a further embodiment of the invention, the user interface may allow setting of sensor threshold values for conditional scene descriptions.

According to a further embodiment of the invention, the user interface may allow setting different lighting effects for different sensor values.

In a further embodiment of the invention, code generation means may generate the abstract light scene description from the user interface selections of locations and/or targets and respective lighting effects for the selected locations and/or targets.

According to a further embodiment of the invention, a computer program is provided, wherein the computer program may be enabled to carry out the method according to the invention when executed by a computer.

According to an embodiment of the invention, a record carrier such as a CD-ROM, DVD, memory card, floppy disk or similar storage medium may be provided for storing a computer program according to the invention.

In a further embodiment of the invention, a computer may be programmed to perform a method according to the invention and may comprise communication means for communicating with a lighting system.

These and other aspects of the invention will be apparent from and elucidated with reference to the embodiment(s) described hereinafter.

The invention will be described in more detail hereinafter with reference to exemplary embodiments. However, the invention is not limited to these exemplary embodiments.

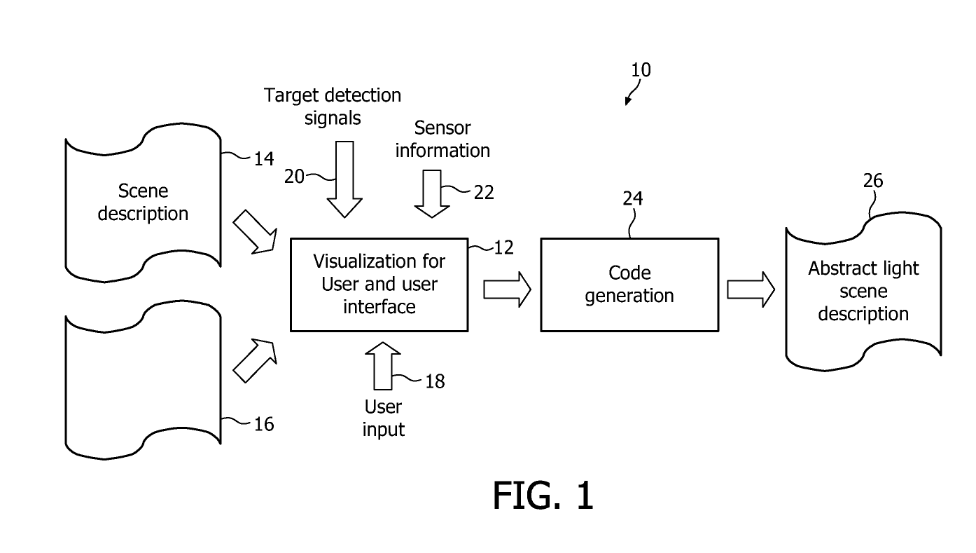

FIG. 1 shows a block diagram of an embodiment of the light control system with a user interface for interactively changing settings in a lighting system according to the invention;

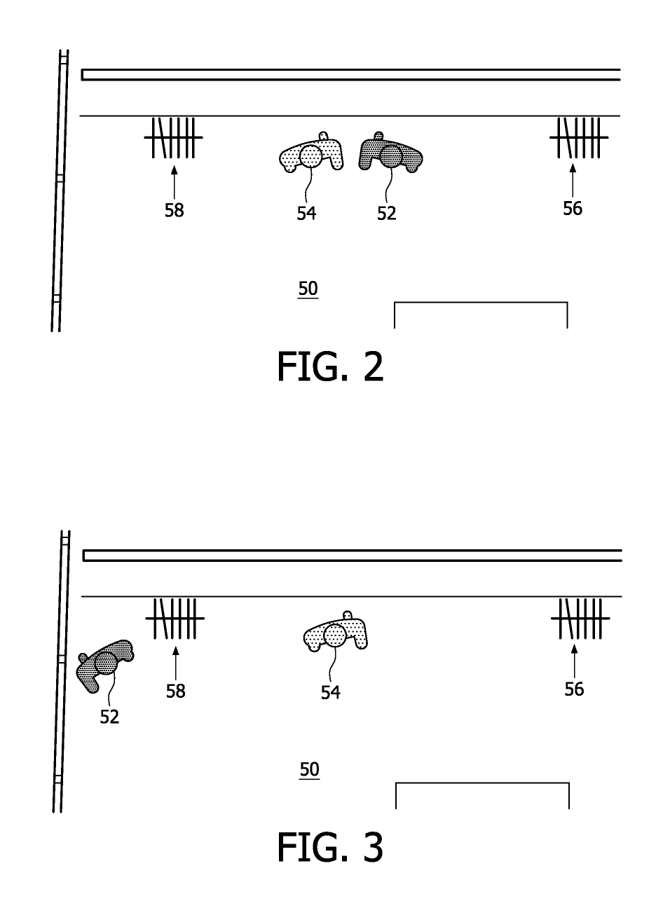

FIGS. 2 and 3 show exemplary graphical representations of sceneries to be lit in a shop according to the invention.

In the following description, (functional) similar or identical elements in the drawings may be denoted with the same reference numerals.

FIG. 1 shows a schematic block diagram of a light control system 10 with a user interface (UI) 12, for example a graphical user interface (GUI) such as used for conventional computer programs for modern graphical operating systems (OS). The user interface 12 allows user inputs 18 with input means such as a computer mouse, a keyboard, a joystick, a trackball, touch screen, a graphics pen, a tablet or similar input means for GUIs. The light control system 10 with the UI 12 is implemented as computer program which is executed by a computer, such as conventional Personal Computer (PC) running under a conventional OS with a GUI. A PC executing the computer program implementing the light control system 10 is provided as control computer for a complex lighting system, for example a lighting system of a shop or chain of shops.

Furthermore, a scene description file 14 is provided, which comprises a description of a scenery to be lit by means of a XML light description language such as the LightMan approach which allows designing lighting scenes totally independent of the installed lamps or targeting areas. During the LightMan software process a design gets compiled taking the room architecture and the available lamps into account. Result of this compilation is the set of lamp settings to realize a best approximation of the initially designed light effects or lighting scene. The scene description file 14 serves as source for the light control system 10 to calculate a graphical, two-dimensional representation of a room or a scenery to be lit for displaying it with the UI 12.

FIGS. 2 and 3 show such graphical and two-dimensional representations of sceneries to be lit 50 in a shop as they may be displayed with the UI 12. In FIGS. 2 and 3, the layout of a shop is represented with two mannequins 52 and 54 and two clothing racks 56 and 58. The difference between the two sceneries is the position of the first mannequin 52: in FIG. 2, the first mannequin 52 is positioned besides the second mannequin 54, while in FIG. 3, the first mannequin 52 is located in a corner of the shop. Both sceneries may require different lighting effects for the first mannequin 52. For example, in the scene shown in FIG. 2, both mannequins 52 and 54 may be illuminated with the same lamp, while in the scene shown in FIG. 3, the mannequin 52 requires a different illumination than mannequin 54 standing in a different area of the shop.

The graphical representations allow a user to interactively design new sceneries to be lit by presenting a selection of possible lighting effects for a location or target selected by the user with the UI 12. For example, if the user selects a corner or wall of a room, the UI 12 automatically shows the lighting effects available for the selected location. Or, if a user selects for example a mannequin with the UI 12, the UI 12 automatically represents available lighting effects for this selected target. The possible lighting effects can be pre-programmed effects, pictures or changeable parameters like color, color temperature or brightness. Only parameters that make sense for an activated area/location or target are available. For example, for a mannequin lights not the wall washing effects are presented and the other way round.

This feature requires that the light control system knows about the specific installation of a light system, for example the installed lamps and their possible lighting effects. This knowledge is stored in an effect database 16 as part of the light control system 10. The lighting effects may be read from the effect database 16 when a location or target is selected via the UI 12, or when the scene description file 16 is read and processed for displaying with the UI 12, the lighting effects for each location or target may be read also from the effect database 16 and stored for example in the memory of the computer showing the UI 12. The latter has the advantage that the available lighting effects for a selected item in the UI 12 may be shown more quickly in contrast to the former method, where the available lighting effects must be reloaded which requires, however, less memory.

Additional inputs for the UI 12 are target detection signals 20 and sensor information 22. The target detection signals 20 may be sent out by specific targets such as mannequins and received by a target detector, which is connected to the computer system with the UI 12. This allows to detect targets such as mannequins or clothing rails in a shop and to automatically show them in the graphical representation of the scenery to be lit presented via the UI 12. The sensor information 22 may be received from certain sensors located in the shop, particularly movement sensors. If a movement sensor detects movement in its surveillance area, it sends out sensor information containing the coordinates of the sensor and a value about the movement. This sensor information is received by the light control system 10. The UI 12 then may reflect the received sensor information by recoloring the area in which the sensor is located by extracting the coordinates from the received sensor information, for example by highlighting the area where movement was detected. This allows a user to change sensor value dependant lighting in this area, for example to switch on a more attracting lighting such as blinking in order to influence shoppers walking through this area. In this way, monitoring of sensor function, sensitivity field and level can be accomplished. The UI 12 may also allow setting sensor threshold values for conditional lighting scene descriptions. For example, the UI 12 may allow setting different effects for different sensor values. Manual override through the UI 12 may allow reviewing all conditional light effects regardless of the real sensor value.

The interactively created scenery to be lit from the UI 12 is processed with code generation means 24, which generate an abstract light scene description file 26 for further processing, particularly for creating a set of control values for a concrete lighting system. The control values may be generated by compiling the abstract light scene description file 26 with a special compiler program adapted for compiling control values for lighting systems from abstract light scene descriptions. The abstract light scene description file 26 is typically a XML file containing an abstract description of the interactively created scenery to be lit for a certain lighting system.

The invention is particularly applicable to interior and exterior light control systems. Especially, it is applicable for interactive light adjustments in shops and showrooms.

At least some of the functionality of the invention may be performed by hard- or software. In case of an implementation in software, a single or multiple standard microprocessors or microcontrollers configuration may be used. The invention might be implemented by single or multiple algorithms.

It should be noted that the word “comprise” does not exclude other elements or steps, and that the word “a” or “an” does not exclude a plurality. Furthermore, any reference signs in the claims shall not be construed as limiting the scope of the invention.

1. Light control system comprising a user interface for interactively changing settings in a lighting system, wherein the user interface is configured to graphically represent a scenery to be lit by the lighting system and to facilitate selection of locations and targets of the scenery and lighting effects for a selected location or target, wherein the light control system receives detection signals associated with the locations and targets and wherein the user interface displays or hides the locations and targets in response at least to the detection signals.

2. The light control system of claim 1, wherein the light control system is configured to generate an abstract light scene description depending on the user interface selections of a location or target and a lighting effect for the selected location and target.

3. The light control system of claim 1, wherein the user interface is further configured to present the lighting effects for a location or target after the selection of the location or target.

4-5. (canceled)

6. The light control system of claim 1, comprising a lighting effects database.

7. (canceled)

8. The light control system of claim 1, being further configured to receive sensor information, wherein the user interface is configured to represent the received sensor information.

9-12. (canceled)

13. A method for interactively changing settings in a lighting system with a user interface, the method comprising
graphically representing a scenery to be lit with the user interface,
selecting locations and targets of the scenery and lighting effects for a selected location or target, and
receiving detection signals for targets, wherein the user interface displays or hides targets in response in part to the received detection signals.

14. The method of claim 13, further comprising creating an abstract light scene description depending on the selections of a location or target and a lighting effect for the selected location and target.

15. The method of claim 14, further comprising presenting the lighting effects for a location or target after the selection of the location or target.

16. The method of claim 15, further comprising presenting only appropriate lighting effects for a selected location or target.

17. (canceled)

18. The method of claim 14, further comprising reading lighting effects, which are connected to the selected location or target, from a lighting effects database.

19. (canceled)

20. The method of claim 14, further comprising receiving sensor information, wherein the user interface reflects the received sensor information in the graphically represented scenery to be lit.

21. The method of claim 20, wherein the user interface reflects the received sensor information in the graphically represented scenery by recoloring certain targets or locations related to the received sensor information.

22-27. (canceled)
